(19) United States
(12) Patent Application Publication
(10) Pub. No.: US 2019/0243148 A1
(43) Pub. Date: Aug. 8, 2019

(54) OPTICAL DEVICE EMPLOYING ELECTRICALLY ADDRESSED SPATIAL LIGHT MODULATOR

(71) Applicant: APPLEJACK 199 L.P., San Jose, CA (US)

(72) Inventor: Wojciech J. Walecki, Sunrise, FL (US)

(21) Appl. No.: 15/887,679

(22) Filed: Feb. 2, 2018

(51) Int. Cl. G02B 27/10; G02F 1/13; G02B 5/30; G01J 3/44

(52) U.S. Cl. CPC G02B 27/1026; G02F 1/13; G02B 27/0944; G01J 3/44; G02B 5/3025

(57) ABSTRACT

A device is described allowing simultaneous control of angles at which an optical beam is impinging a sample and at which radiation emitted by the sample is collected. The device comprises a first electrically addressed spatial light modulator configured to block input light and produce an excitation radiation for irradiating a sample at the predetermined incidence angle; a second electrically addressed spatial light modulator configured to produce the detection radiation corresponding to the predetermined collection angle; and at least one controller configured to control at least one of: the predetermined incidence angle by controlling the first electrically addressed spatial light modulator and the predetermined collection angle by controlling the second electrically addressed spatial light modulator. The device can be applied in the field of Raman spectroscopy for investigation, which can be used to identify tensor components of stress in silicon wafers.

### TECHNICAL FIELD

The present disclosure relates to an optical device that employs an electrically addressed spatial light modulator.

### BACKGROUND

The selection rules used in Raman spectroscopy often require control of the angle at which an optical beam irradiates a sample and control of the angle at which Raman emission is collected. Often certain resonances are manifested only at particular incidence and collection angle combinations. In research and development laboratory environments this is often accomplished using separate optics for control of excitation and collecting emitted radiation.

### SUMMARY

The present disclosure provides an optical device for irradiating a sample at a predetermined incidence angle and collecting a detection radiation at a predetermined collection angle.

In one embodiment, the optical device includes a first electrically addressed spatial light modulator configured to block input light and produce an excitation radiation for irradiating a sample at the predetermined incidence angle. The optical device includes a second electrically addressed spatial light modulator configured to produce the detection radiation corresponding to the predetermined collection angle. The apparatus includes at least one controller configured to control at least one of: the predetermined incidence angle by controlling the first electrically addressed spatial light modulator and the predetermined collection angle by controlling the second electrically addressed spatial light modulator.

In another embodiment, the optical device includes a source for generating an input light. The optical device includes a first electrically addressed spatial light modulator located in an optical path of the input light. The first electrically addressed spatial light modulator is configured to partially block input light and produce an excitation radiation having a predetermined spatial characteristic. The optical device includes at least one focusing element configured to focus the excitation radiation at a predetermined incidence angle onto a surface of a sample. The predetermined incidence angle is based on the predetermined spatial characteristics of the excitation radiation. The at least one focusing element is further configured to collect radiation emitted by the sample and produce a collimated radiation. The optical device includes a second electrically addressed spatial light modulator located in an optical path of the collimated radiation. The second electrically addressed spatial light modulator is configured to partially block the collimated radiation and produce a detection radiation having a predetermined spatial characteristic. The predetermined spatial characteristics may correspond to a predetermined collection angle. The optical device includes at least one controller configured to control the predetermined incidence angle by controlling the first electrically addressed spatial light modulator. The at least one controller is further configured to control the predetermined collection angle by controlling the second electrically addressed spatial light modulator.

### BRIEF DESCRIPTION OF THE DRAWINGS

The present subject matter is illustrated by way of example, and not by way of limitation, in the figures of the accompanying drawings in which:

FIG. 1 schematically illustrates an experimental arrangement used for off-axis Raman measurements.

FIG. 2 schematically illustrates a microscope objective (focusing lens) focusing the laser beam on the wafer in accordance with the teachings of the present disclosure.

FIG. 3 schematically illustrates rays collected by the focusing lens and emerging from a focal point of the focusing lens as described by a pair of angles γ and φ in accordance with the teachings of the present disclosure.

FIG. 4 schematically illustrates a device used for off-axis Raman measurement.

FIG. 5 schematically illustrates an optical device in accordance with the teachings of one embodiment of the present disclosure.

FIG. 6 schematically illustrates an optical device in accordance with the teachings of another embodiment of the present disclosure.

FIG. 7 schematically illustrates an optical device in accordance with the teachings of yet another embodiment of the present disclosure.

FIG. 8 illustrates a flow diagram of a method for irradiating a sample at a predetermined incidence angle and collecting detection radiation at a predetermined collection angle by the optical device, in accordance with the embodiments of the present disclosure.

FIG. 9 illustrates an example hardware configuration of a controller in the optical device, in accordance with the embodiments of the present disclosure.

### DETAILED DESCRIPTION OF SOME EXAMPLE EMBODIMENTS

In a case of Raman spectroscopy of a silicon surface, Loechelt et al., (G. H. Loechelt, N. G. Cave, and J. Menendez, Appl. Phys. Lett., Vol. 66, No. 26, 26, June 1995 and G. H. Loechelt, N. G. Cave, and J. Menendez, J. of Applied Physics, 86, 6164-80, 1999), describes a commonly used backscattering geometry that allows observation of only one longitudinal optical (LO) phonon. Loechelt et al., demonstrates that by conducting an experiment in an off-axis configuration and by controlling the incident angle and polarization state of the incident and collected radiation, it is possible to determine all six independent components of a stress tensor for a cut surface of silicon.

Bonera et al. (E. Bonera, M. Fanciulli, and D. N. Batchelder, Appl. Phys. Lett., Vol. 81, No. 18, 28, October 2002 and E. Bonera, M. Fanciulli, and D. N. Batchelder, J. Appl. Phys., Vol. 94, No. 4, 15 Aug. 2003) notice that by using a high numerical aperture, one can break the selection rules for pure backscattering geometry and one can excite vibration modes forbidden in pure backscattering geometry, and observe the presence and characteristics of other phonons. Furthermore, they discuss angular distribution and application of the polarization control to analyze and determine independently, up to three components of out of six independent strain components in Silicon. Bonera et al points out that the exact values of measured stress tensor components depend upon model assumptions (in particular depend on assumed vanishing elements of the stress tensor).

However, the types of arrangements as disclosed in Loechelt et al., and Bonera et al., are quite complicated and difficult to implement in a commercial tool. Furthermore, this type of lateral resolution of a spectroscopic system deteriorates, and cannot be implemented in a micro-Raman tool.

In WO2007/040488, the inventors described an optical probe comprising an entrance aperture partially blocking exciting radiation, and being mounted in front of, and to, an optical beam-splitter directing exciting radiation towards the focusing element and being mounted in front of a focusing element, directing focused exciting radiation on the surface of a sample being in optical communication with the focusing element and the sample is mounted to a wafer chuck mechanically connected to the focusing element, at an incidence angle predetermined by the opening in the aperture; and a second aperture mounted on another side of the optical beam-splitter in such way that said aperture is partially blocking the radiation emitted by the sample, which was collected and collimated by the focusing element, where the opening of the second aperture defines the collection angle.

The aforesaid optical probe allows for wide control of the incidence and collection angles of the excitation beam and Raman emission respectively, while preserving relatively high spatial resolutions. The optical probe furthermore allows for measurements and imaging of the features significantly smaller than the spot size of the excitation beam on the sample surface. The optical probe furthermore allows for measurement of off-axis Raman emissions without the need to realign the excitation and collection optics and without the need to rotate the wafer during measurement

Despite the fact that the optical probe as disclosed in WO2007/040488 provides the aforesaid advantages, the entrance aperture and the second aperture as used therein are of a mechanical type. Thus, to vary the partially blocking, the entrance aperture and the second aperture had to be replaced. Furthermore, to control the incidence angle and/or the collection angle, the mechanical apertures needed to be mounted on motorized filter wheels or other suitable moving stages. In addition, WO2007/040488 disclosed varying the polarization states of the incident and emitted radiation by using additional elements such as quarter-wave plates and polarizers mounted on rotation stages. Controlling position of the mechanical apertures, the quarter-wave plates and the polarizers is substantially complicated in this case. As such, according to one or more embodiments of the present disclosure, an optical device is described for irradiating a sample at a predetermined incidence angle and collecting a detection radiation at a predetermined collection angle. This allows wide control of the incidence and collection angles of the excitation beam and Raman emission respectively, while preserving relatively high spatial resolutions. To this end, the optical device includes a first electrically addressed spatial light modulator and a second electrically addressed spatial light modulator. The predetermined incidence angle is achieved by placing the first electrically addressed spatial light modulator along an optical path of an input light. The predetermined collection angle is achieved by placing the second electrically addressed spatial light modulator along an optical path of an collimated radiation. The optical device further includes a controller to control the first electrically addressed spatial light modulator and the second electrically addressed spatial light modulator, and consequently to control the incidence angle and the collection angle. This arrangement allows convenient control of incidence angle and collection angle, and measurement of off-axis Raman emissions without the need to manually replace the mechanical apertures.

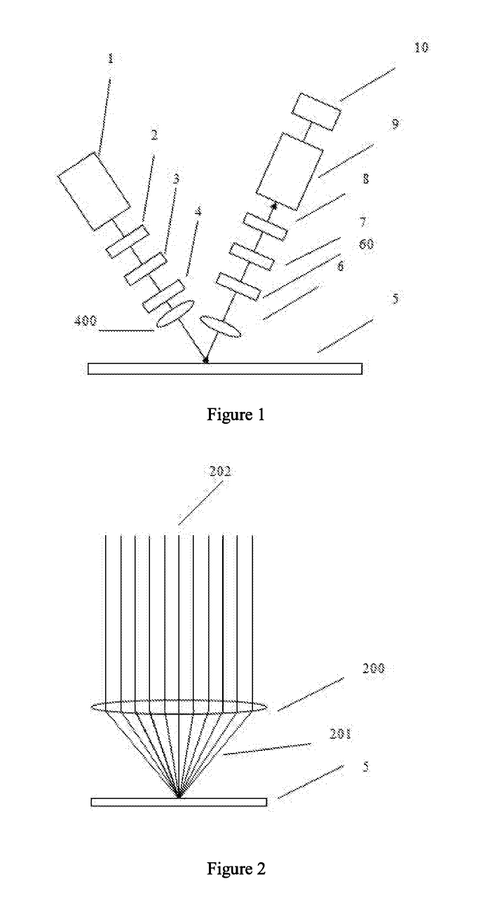

FIG. 1 illustrates an experimental arrangement that may be commonly used for off-axis Raman measurements. A laser 1 is emitting an input laser beam which is filtered by a spectral filter 2, the polarization of the beam emerging from spectral filter 2 is rotated by a half wave plate 3, ellipticity of the polarization state of the beam is controlled subsequently by a quarter-wave plate 4. The radiation emerging from the quarter-wave plate 4 is focused on a sample 5 using a focusing lens 400. A collection lens 6 collects a radiation emitted by the sample, which is filtered by a spectral filter 60. The polarization state of the beam is analyzed by a combination of quarter-wave plate 7 and polarizer 8. Subsequently, the beam is spectrally analyzed by spectrometer 9 and detected by array detector 10. A similar experimental arrangement was used by Loechelt et al. In their work, Loechelt et. al., were using an incidence angle approximately equal to 60 degrees.

Loechelt et al teaches that by measuring Raman emission from silicon wafer oriented in a crystallographic direction at various incidence angles with respect to the crystallographic orientation of the wafer and at various polarization angles, one may establish six independent components of stress tensor of the material. Loechelt et al provides an explicit prescription for the stress tensor calculation. However, it is straightforward to anyone skilled in the arts that the results presented by Loechelt et al can be generalized to any material possessing the same (diamond) crystal structure.

Loechelt et al defined a procedure in which they specify which combination of incidence, emission angles and polarization states for incidence and emission angle should be used in order to accurately measure all the components of the stress tensor.

As per Loechelt et al in a diamond-structure semiconductor like silicon, there are three Raman-active optical phonon modes: two transverse optical (TO) phonon modes (TO1 and TO2) and one longitudinal optical (LO) phonon mode. Because unstrained silicon has cubic symmetry, these three phonons are degenerate in frequency at k=0. Non-hydrostatic crystal strain destroys this symmetry and lifts the degeneracy. The splitting in phonon frequencies and the mixing of the phonon modes contain complete information about the stress that destroyed the symmetry. However, if only one of these three phonons is observed, as in conventional backscattering Raman spectroscopy, only partial information can be obtained about the stress.

The intensity of a phonon mode for a given scattering geometry can be determined by examining the Raman polarizability tensors. For phonons with a wave number of k=0 appropriate for Raman scattering, one can choose the polarizations of the three degenerate optical phonons to be any set of three mutually perpendicular vectors. If the three cubic axes are chosen, the Raman polarizability tensors are given by:

$${TO}_{1} \to {Δ}_{1} = ( \begin{matrix}0 & 0 & 0 \\ 0 & 0 & d \\ 0 & d & 0\end{matrix} ) , \\ {TO}_{2} \to {Δ}_{2} = ( \begin{matrix}0 & 0 & d \\ 0 & 0 & 0 \\ d & 0 & 0\end{matrix} ) , \\ LO \to {Δ}_{3} = ( \begin{matrix}0 & d & 0 \\ d & 0 & 0 \\ 0 & 0 & 0\end{matrix} ) . \qquad Equation 1$$

In this notation, TO1, TO2, and LO denote phonon modes polarized in the [100], [010], and [001] directions, respectively, and d represents a nonzero number. This particular choice of phonon basis and nomenclature is useful for interpreting the results of backscattering experiments from a [001] crystal surface.

The Raman polarizability tensors determine the intensity of the scattered light from the sample according to

Iₖ=Ξ|p′^{T}Δₖp|²I₀. Equation 2

where Iₖ is the intensity from the kth phonon mode (TO1, TO2, or LO), Ξ is a constant related to the Raman scattering cross-section, p′ is the polarization vector of the scattered light, Δₖ is one of the polarizability tensors given above, p is the polarization vector of the incident light inside the sample, I₀ is the intensity of the incident light, and the superscript T denotes transposed vector. The signal line shape Λₖ for a given phonon mode with a frequency of vk is given by a Lorentzian function of the form:

$${Λ}_{k} ( ω ; {ω}_{k} ) = \frac{{I}_{k} Γ}{{( ω - {ω}_{k} )}^{2} + {Γ}^{2}} , \qquad Equation 3$$

where ω is the difference in frequency between the incident and scattered light (Raman frequency), and Γ is the half width at half maximum of the signal. The total signal line shape Λ(ω) is the sum of the signals from the three contributing phonon modes,

$$Λ ( ω ) = {\sum }_{k = 1}^{3} {Λ}_{k} ( ω ; {ω}_{k} ) . \qquad Equation 4$$

For unstrained silicon, all three phonon modes are degenerate with a frequency of ωₖ=ω₀=520.3 cm) at room temperature (22° C.).

In the presence of strain τ the phonon frequencies ωₖ shift from their unstrained value Wo. Using degenerate perturbation theory, the new phonon frequencies and polarizations follow from the eigenvalues and eigenvectors of the following secular matrix.

$$Ψ ( τ ) {d}_{k} = {λ}_{k} {d}_{k} , \\ Ψ ( τ ) = ( \begin{matrix}\begin{matrix}p {ϵ}_{11} + \\ q ( {ϵ}_{22} + {ϵ}_{33} )\end{matrix} & 2 r {ϵ}_{12} & 2 r {ϵ}_{13} \\ 2 r {ϵ}_{21} & p {ϵ}_{22} + q ( {ϵ}_{33} + {ϵ}_{11} ) & 2 r {ϵ}_{23} \\ 2 r {ϵ}_{31} & 2 r {ϵ}_{32} & p {ϵ}_{33} + q ( {ϵ}_{11} + {ϵ}_{22} )\end{matrix} ) \qquad Equation 5$$

These eigenvalues and eigenvectors are related to the shifted phonon frequencies ωₖ in the following fashion:

$${λ}_{k} = {ω}_{k}^{2} - {ω}_{0}^{2} = ( {ω}_{k} + {ω}_{0} ) ( {ω}_{k} - {ω}_{0} ) \approx 2 {ω}_{0} ( {ω}_{k} - {ω}_{0} ) , \\ {ω}_{k} \approx {ω}_{0} + \frac{{λ}_{k}}{2 {ω}_{0}} . \qquad Equation 6$$

Since the Raman tensors are the derivatives of the system's electronic polarizability relative to the phonon normal coordinates, and the normal coordinates under stress are linear combinations of the normal coordinates for the unstressed material, as is apparent from Eq. (5), the Raman polarizability tensors for the perturbed phonons can be easily written as linear combinations of the tensors, in the first order approximation in Eq. (1) as:

$${D}_{k} = {\sum }_{i = 1}^{3} {{Δ}_{i} ( {d}_{k} )}_{i} . \qquad Equation 7$$

In the preceding equations, Ψ(τ) is a 3×3 secular matrix whose components are linear functions of the strain tensor ϵ, which is ultimately related to the stress tensor σ through the compliance tensor s. The parameters p, q, and r are deformation potential constants. The strain tensor ϵ is related to the stress tensor σ by Hooke's law, which states that ϵ=sσ. For crystalline silicon, s has only three different components. Also, (dₖ)ᵢ represents the ith component of the kth normalized eigenvector. The approximations in Eq. (6) are valid since ω_{k′} are clos to ω₀.

Further, it has been demonstrated by Loechelt et al that the incident light is tilted away from the normal axis, the scattered light is collected normally, and both beams are polarized. By allowing the incident light to deviate from normal incidence, all three active optical phonon modes are accessible for measurement. Furthermore, the polarizers enable the experimenter to vary the relative contribution of these three modes to the measured signal intensity. This combination of off-axis illumination with polarization is more powerful and general than polarized backscattering methods, which can only determine the in-plane stress components for special crystal orientations. If one judiciously selects the various angles of the apparatus, a given phonon mode can be selectively studied. By analyzing the results of several selective measurements, all six components of the stress tensor can be determined.

Also, further simplification can be achieved by efficiently relating the secular matrix to the components of the stress tensor σ. First, the symmetry of Ψ(σ) implies that there are only six independent components and said matrix has form:

$$Ψ ( σ ) = ( \begin{matrix}{ψ}_{1} & {ψ}_{6} & {ψ}_{5} \\ {ψ}_{6} & {ψ}_{2} & {ψ}_{4} \\ {ψ}_{5} & {ψ}_{4} & {ψ}_{3}\end{matrix} ) \qquad Equation 8$$

where vector ψ is given by

ψ=πsσ Equation 9

where π is a matrix of deformation potential constants s in compliance matrix, and σ is a stress tensor expressed in six component vector form convention. In a linear model, stress σ is given as a linear form with a vector of adjustable parameters (model parameters) x.

σ=Tx Equation 10

From Eq. 9 and Eq. 10 we see that ψ is also a linear function of vector x. Thus, Loechtel et al., has shown that it is possible to find all relevant stress components from the experiment in which incidence θ angle is constant, the angle between the [100] axis of the crystal (in plane of the surface) and the projection of the incidence beam direction on the surface of crystal φ, and angles α, β describing direction of linear polarizers inserted in the incident and scattered beam paths. The four angle combination (θ, φ, α, β) describes the configuration of off-axis Raman measurement. The full measurement comprises of series of experiments in r configurations defined by angles (θ, φⱼ, αⱼ, βⱼ) where r=1, . . . , r.

The calculation of model vector parameter x is performed by fitting predicted line shapes given by equation 4 to experimentally observed line shapes for every experiment j. This is accomplished by minimizing parameter χ² as a function of its arguments (x, and Ξ):

$${χ}^{2} ( x , Ξ ) = {\sum }_{j = 1}^{r} {χ}^{2} ( x , Ξ , θ , {α}_{j} , {ϕ}_{j} , {β}_{j} ) \qquad Equation 11$$

where we implicitly assumed that all experiments j=1, . . . ,r have been performed under the same or similar experimental conditions (same apparatus, same exposure times etc.), where

$${χ}^{2} ( x , Ξ , θ , {α}_{j} , {ϕ}_{j} , {β}_{j} ) = \frac{{\sum }_{i = 1}^{n} {[ {Λ}_{exp , j} ( {ω}_{i} ) - {Λ}_{j} ( {ω}_{i} ) ]}^{2}}{n} \qquad Equation 12$$

where ωᵢ is the frequency at which observation is performed and corresponds to one point of n points comprising Raman emission spectrum.

By finding absolute minimum of the function [symbol] ²(x,Ξ) we find the value of x vector optimizing fit, and stress tensor components in the sample using Equation 10.

Let us consider a microscope objective (or alternatively referred to as “focusing element”) 200 presented in FIG. 2 focusing the laser beam on sample 5 a microscope objective 200. The angle between a marginal ray 201 and a chief ray 202 may define the Numerical Aperture (NA) of the system. The rays emerging from the microscope objective 200 may generally propagate inside a cone defined by the angle between the marginal ray and the chief ray. The angle between the chief ray 202 and the marginal ray 201, in case of the typical commercial 60× microscope objective, is often in the range of 58-71 degrees (which corresponds to NA=0.85−0.95). This angle is essentially the same as the incidence angle of 60 degrees used by Loechelt et al.

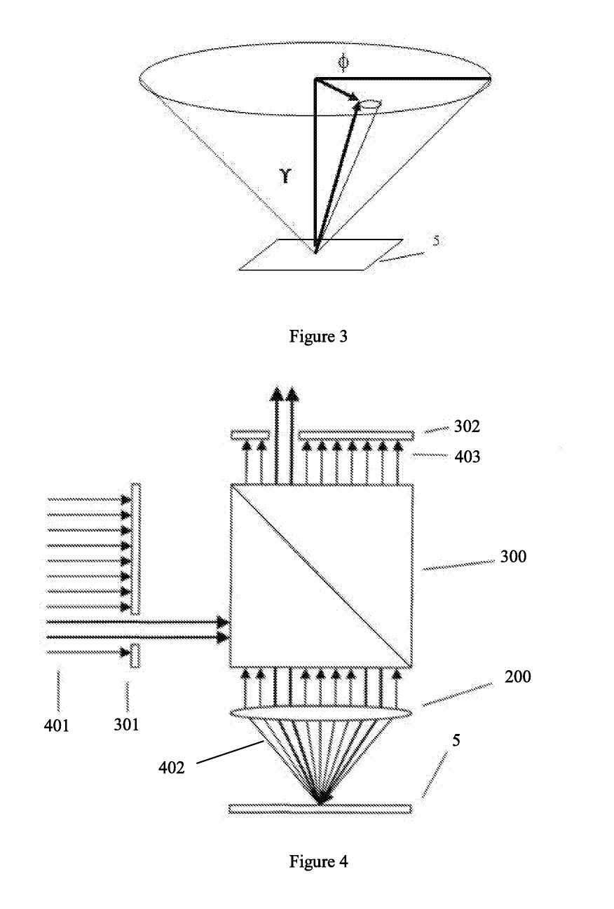

As illustrated in FIG. 3, every ray collected by the microscope objective 200 and emerging from a focal point of the objective may be described by a pair of angles γ and φ. Therefore, by defining angular coordinates γ and φ of rays propagating from a focal point of the microscope objective 200, it is possible to select a portion of the spherical angle within the cone, defined by marginal rays, so as to correspond to the same or essentially the same geometry of measurement as that described in Loechelt et al.

Based on the above concept, in WO2007/040488, the inventors proposed a device, based upon a microscope objective and a pair of mechanical apertures to reproduce the off-axis geometry. As illustrated in FIG. 4, the device of WO2007/040488 included a mechanical entrance aperture 301 to partially block input light 401. The mechanical entrance aperture 301 is mounted in front of an optical beam-splitter 300 directing the excitation radiation towards the microscope objective or focusing element 200. The focusing element 200 directs focused exciting radiation on to the surface of the sample 5 at an incidence angle predetermined by the opening in the mechanical aperture. The device further comprises a second mechanical aperture 302 mounted on another side of the optical beam-splitter 300 in such a way that said second mechanical aperture 302 is partially blocking the radiation 402 emitted by the sample 5, which was collected and collimated into the collimated radiation 403 by the focusing element 200, where the opening of the second mechanical aperture 302 defines the collection angle.

Thus, in the device described in WO2007/040488, the angle φ was proposed to be changed by suitably defining angular co-ordinates γ and φ of rays propagating from a focal point of a microscope objective by suitably controlling a mechanical aperture. In particular, to vary a size of the partial block, the mechanical aperture had to be replaced. Furthermore, to control the incidence angle and/or the collection angle, the mechanical apertures needed to be mounted on motorized filter wheels or other suitable moving stages.

In addition to the above, polarization states of the incident and emitted radiation (i.e. angles α, β) is controlled using the polarizers. In particular, to vary the polarization states of the incident and emitted radiation, additional elements such as quarter-wave plates and polarizers are utilized. In particular, the position of quarter-wave plates and polarizers with respect to the incident radiation and emitted radiation is changed by rotation stages.

To vary the partially blocking characteristics, the mechanical entrance aperture 301 and the second mechanical aperture 302 had to be replaced. Furthermore, controlling the position of the mechanical entrance aperture 301, the second mechanical aperture 302, the quarter-wave plates and the polarizers are substantially complicated and have a restriction in terms of the level of accuracy.

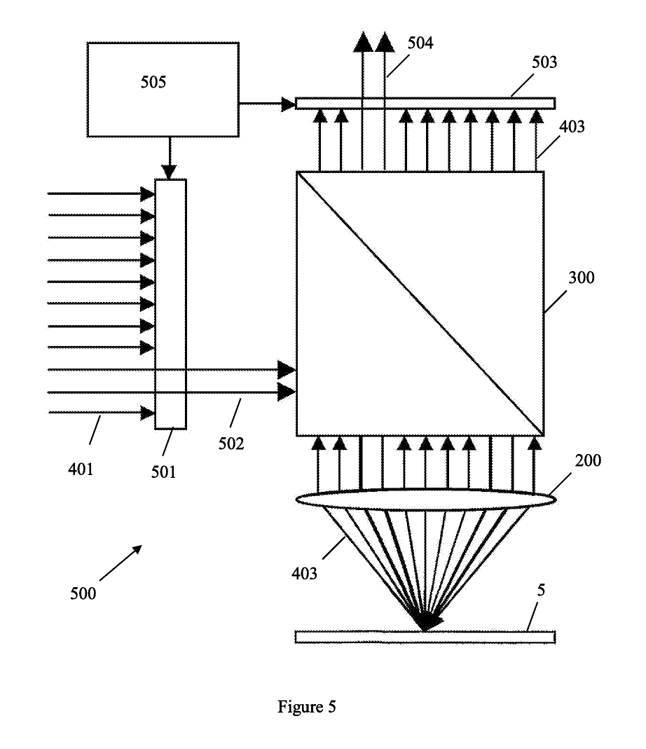

Thus, referring to FIG. 5, in one embodiment, the present disclosure provides an optical device 500 that includes a first electrically addressed spatial light modulator 501 configured to block input light 401 and produce an excitation radiation 502 for irradiating a sample 5 at the predetermined incidence angle. In an example, the optical device 500 is a microscope probe.

The optical device 500 includes a second electrically addressed spatial light modulator 503 configured to produce the detection radiation 504 corresponding to the predetermined collection angle. The optical device 500 includes at least one controller 505 configured to control at least one of: the predetermined incidence angle by controlling the first electrically addressed spatial light modulator 501 and the predetermined collection angle by controlling the second electrically addressed spatial light modulator 503.

In an embodiment of the present disclosure, the first electrically addressed spatial light modulator 501 includes a liquid crystal array.

In another embodiment of the present disclosure, the first electrically addressed spatial light modulator 501 includes a digital micro-mirror device.

In an embodiment of the present disclosure, the second electrically addressed spatial light modulator 503 includes a liquid crystal array.

In another embodiment of the present disclosure, the second electrically addressed spatial light modulator 503 includes a digital micro-mirror device.

By way of a non-limiting example, the digital micro-mirror device can be of a configuration as described in Hornbeck, Larry J. “Current status of the digital micromirror device (DMD) for projection television applications.” Electron Devices Meeting, 1993. IEDM'93. Technical Digest., International. IEEE, 1993, contents of which are incorporated by reference herein in its entirety.

By way of a non-limiting example, the liquid crystal array can be of a configuration as described in U.S. Pat. No. 4,389,096, contents of which are incorporated by reference herein in its entirety.

As would be understood, an electrically addressed spatial light modulator may convert the electrical signal to spatially modulate amplitude, phase, or polarization of light waves in space and time. The liquid crystal (LC) molecules of the liquid crystal array or the mirrors of the digital micro-mirror device act as a switch that either blocks or transmits light, thereby forming an aperture. Thus, when an electrical field is applied to the liquid crystal array or the digital micro-mirror device based on the electric signal from the controller, the LC molecules or the mirror align in direction of the electric field. Based on the direction of the light and the direction of the LC molecules or the mirror, the light undergoes either phase modulation; or amplitude and phase modulation. If the modulation is in the direction of the LC molecules or the mirror, the light is allowed to pass along the direction of the electric field in areas where light is more intense. On the contrary, the light is blocked when modulation is in the orthogonal direction of the LC molecules or the mirror. Thus, the electric field is applied such that only certain LC molecules or certain mirrors are aligned in a manner to allow only a portion of the light to pass through, thereby defining an optical aperture through which only a portion of light is passed.

Now, referring to FIG. 3 and corresponding description, the incident angle of a light beam is defined by the angular coordinates α and θ of rays; and the collection angle of a light beam is defined by the angular coordinates β and φ of rays. These angular coordinates can be varied by aligning the LC molecules or the mirrors. Thus, when the light is modulated by the electrically addressed spatial light modulator, the angular coordinates are varied accordingly. Consequently, the portion of light passing through the optical aperture enables focusing of the excitation radiation at an incidence angle that is determined based on the angular coordinates thus varied. Similarly, the portion of light passing through the optical aperture enables focusing of the collimated radiation at a collection angle that is determined based on the angular coordinates thus varied.

In an embodiment of the present disclosure, the optical device 500 may further comprise at least one focusing element 200 configured to focus the excitation radiation 502 at the predetermined incidence angle onto a surface of the sample 5. In an embodiment of the present disclosure, the at least one focusing element 200 is further configured to collect a radiation 402 emitted by the sample 5 and produce a collimated radiation 403.

In an embodiment of the present disclosure, the optical device 500 may further comprise an optical beam-splitter 300 located between the first electrically addressed spatial light modulator 501 and the focusing element 200 for directing the excitation radiation 502 towards the focusing element 200. The optical beam-splitter 300 is furthermore located between the focusing element 200 and the second electrically addressed spatial light modulator 503 for directing the collimated radiation 403 towards the second electrically addressed spatial light modulator 503.

Although not illustrated, the input light is produced by a laser source. The laser source may form part of the device or may be external thereto.

Although not illustrated, the detection radiation may be analyzed by a spectrometer. The spectrometer may, in particular, be configured to perform spectral analysis of the detection radiation. The spectrometer may form part of the device or may be external thereto.

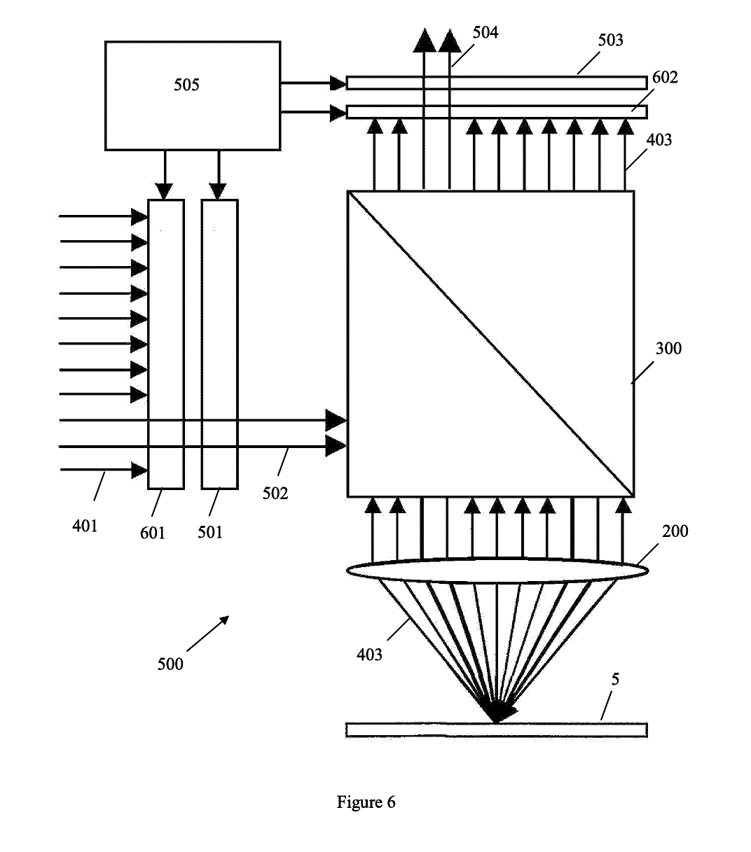

Referring to FIG. 6, in one embodiment, the optical device 500 may include a polarizer 601 configured to control a polarization state of the excitation radiation. The polarizer 601 for controlling the polarization state of the excitation radiation may be located in front of the first electrically addressed spatial light modulator 501.

The optical device 500 may further include a polarizer 602 configured to control a polarization state of the detection radiation. The polarizer 602 for controlling the polarization state of the detection radiation may be located in front of the second electrically addressed spatial light modulator 503.

In an embodiment, at least one of the polarizer 601 for controlling a polarization state of the excitation radiation or the polarizer 602 for controlling a polarization state of the detection radiation may include quarter-wave plate based polarizer that may be mounted on the mounting stage. In another embodiment, at least one of the polarizer 601 for controlling a polarization state of the excitation radiation or the polarizer 602 for controlling a polarization state of the detection radiation may include a liquid crystal based polarization controller. By way of a non-limiting example, the liquid crystal based polarization controller may be of the type as described in Ignacio Moreno, Jeffrey A. Davis, Travis M Hernandez, Don M. Cottrell, and David Sand, “Complete polarization control of light from a liquid crystal spatial light modulator,” Opt. Express 20, 364-376 (2012).

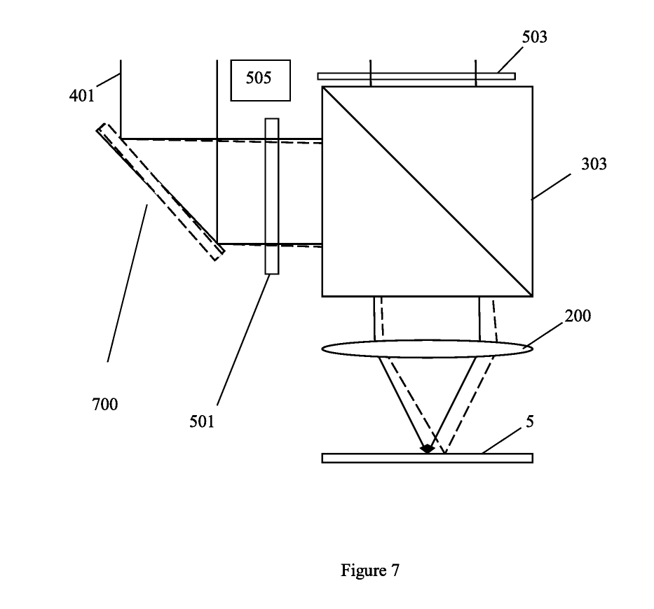

Referring to FIG. 7, the optical device 500 may further include a steering mirror 700. The steering mirror 700 may provide for controlling the angle of incident. As shown in FIG. 7, the input light 401 is deflected by steering mirror 700, subsequently is partially blocked by first electrically addressed spatial light modulator 501 and directed by the optical beam-splitter 300 to a microscope objective 200 and focused at an incident angle defined by the first electrically addressed spatial light modulator 501 on the sample 5. The sample emits radiation, which is collected by the microscope objective 200, passes through the optical beam-splitter 300 and is partially blocked by the second electrically addressed spatial light modulator 503. The radiation transmitted through the second electrically addressed spatial light modulator 503 was emitted by the sample 5 at an emission angle defined by the opening in the second electrically addressed spatial light modulator 503. The exact position of the focal spot is defined by the angle of the steering mirror 700.

The steering mirror angle is controlled by piezo-electric actuators (for example, a mirror mounted on a mirror mount KC-1PZ [8]). Since the focal length of the typical microscope objective described above is of the order of 1-3 mm, and resolution of this mirror mount is 6 arc sec, this arrangement permits positioning the center of the optical beam with a resolution of the order of 20 nm. It is possible to construct a mirror stage having a resolution one order of magnitude higher and achieve control of the position of the center of the optical beam with a resolution of the order of 20 nm. This allows us to further enhance the spatial resolution of our optical system. Resolution is achieved by modulation of the position of the center of the optical beam, which can be at least an order of magnitude higher than the waist of the beam.

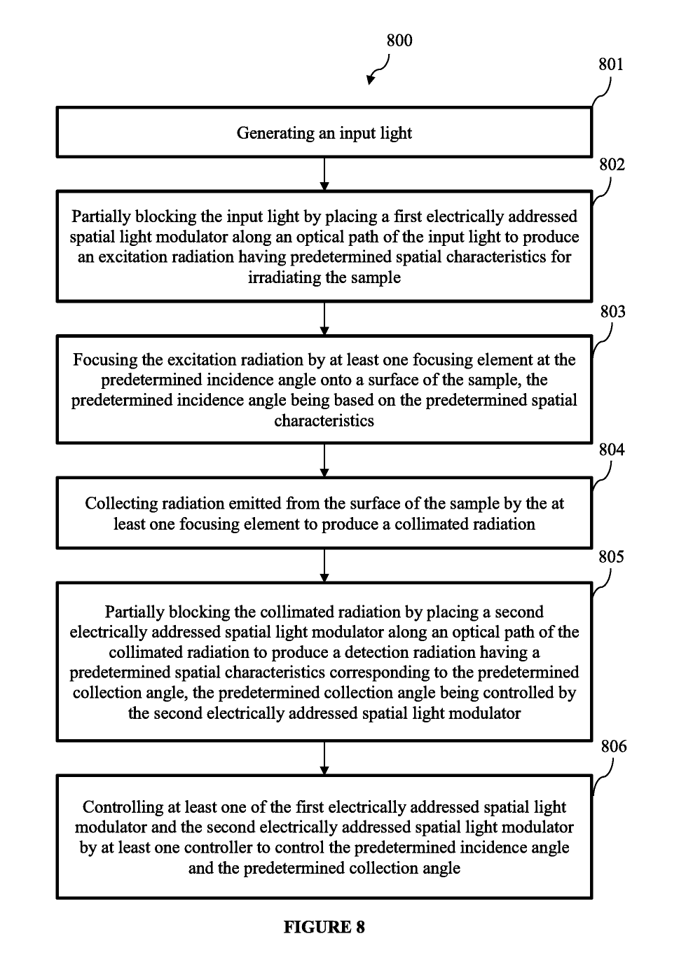

FIG. 8 illustrates a flow diagram of a method 800 for irradiating a sample at a predetermined incidence angle and collecting detection radiation at a predetermined collection angle. The method 800 comprises at step 801 generating an input light. The method 800 comprises at step 802, partially blocking the input light by placing a first electrically addressed spatial light modulator along an optical path of the input light to produce an excitation radiation having predetermined spatial characteristics for irradiating the sample. The method 800 comprises at step 803, focusing the excitation radiation by at least one focusing element at the predetermined incidence angle onto a surface of the sample, the predetermined incidence angle being based on the predetermined spatial characteristics. The method 800 comprises at step 804, collecting radiation emitted from the surface of the sample by the at least one focusing element to produce a collimated radiation. The method 800 comprises at step 805, partially blocking the collimated radiation by placing a second electrically addressed spatial light modulator along an optical path of the collimated radiation to produce a detection radiation having a predetermined spatial characteristics corresponding to the predetermined collection angle, the predetermined collection angle being controlled by the second electrically addressed spatial light modulator. The method 800 comprises at step 806, controlling at least one of the first electrically addressed spatial light modulator and the second electrically addressed spatial light modulator by at least one controller to control the predetermined incidence angle and the predetermined collection angle.

In some embodiments, the method 800 further comprises the step of performing spectral analysis of the detection radiation by the at least one controller to determine the stress tensor of the sample based on the predetermined incidence angle and the predetermined collection angle.

In some embodiments, the method 800 further comprises the steps of controlling a polarization angle of the excitation radiation during irradiating of the sample by the at least one controller; and performing spectral analysis of the detection radiation based on the polarization angle.

In some embodiments, the method 800 further comprises the steps of controlling a polarization angle of the detection radiation by the at least one controller; and performing spectral analysis of the detection radiation based on the polarization angle.

In an example, the steps of performing spectral analysis further comprise following steps as described earlier in reference to FIG. 2 and FIG. 3: performing a series of off-axis Raman measurements with different configurations defined by an excitation incidence angle, a polarization angle of an excitation beam, a collection angle, and a polarization of collection emission conditions in the spectral proximity of (LO) phonon; calculation of the root mean square sum of the deviation of the spectra observed in each of the off-axis Raman measurements and spectra calculated using a model assuming the presence of three nearly degenerate phonons and taking into account linear corrections to the phonon frequencies due to the presence of stress, where stress is a model fitting parameter; calculating the sum of the mean square sum of the deviations for all spectra; minimizing said sum by changing the value of an assumed stress model fitting parameter by iterating the last two steps until the value of the stress model fitting parameter does not change more than a prescribed tolerance; and reporting the value of the model fitting parameter minimizing the sum as a stress tensor.

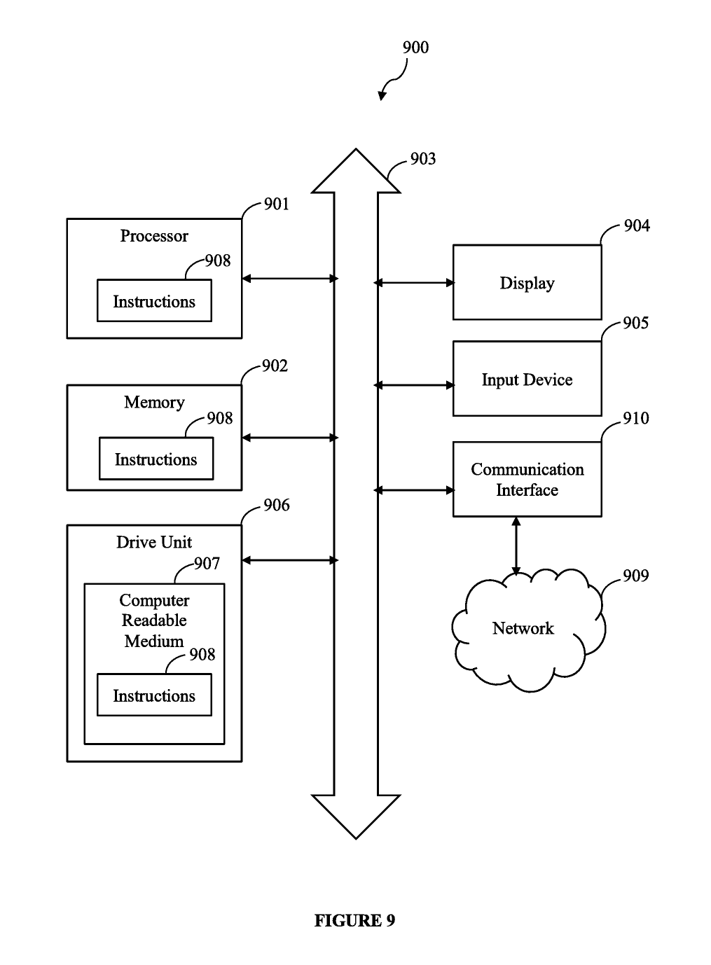

FIG. 9 illustrates an example hardware configuration of the at least one controller 505 in the form of a computer system 900. The computer system 900 can include a set of instructions that can be executed to cause the computer system 900 to perform any one or more of the methods disclosed. The computer system 900 may operate as a standalone device or may be connected, e.g., using a network, to other computer systems or peripheral devices.

In a networked deployment, the computer system 900 may operate in the capacity of a server or as a client user computer in a server-client user network environment or master-slave network environment, or as a peer computer system in a peer-to-peer (or distributed) network environment. The computer system 900 can also be implemented as or incorporated into various devices, such as a personal computer (PC), a tablet PC, a set-top box (STB), a personal digital assistant (PDA), a mobile device, a palmtop computer, a laptop computer, a desktop computer, or any other machine capable of executing a set of instructions (sequential or otherwise) that specify actions to be taken by that machine. Further, while the single computer system 900 is illustrated, the term “device” shall also be taken to include any collection of systems or sub-systems that individually or jointly execute a set, or multiple sets, of instructions to perform one or more computer functions.

The computer system 900 may include a processor 901, e.g., a central processing unit (CPU), a graphics processing unit (GPU), or both, such as the processor 901. The processor 901 may be a component in a variety of systems. For example, the processor 901 may be part of a standard personal computer or a workstation. The processor 901 may be one or more general processors, digital signal processors, application specific integrated circuits, field programmable gate arrays, servers, networks, digital circuits, analog circuits, combinations thereof, or other now known or later developed devices for analyzing and processing data The processor 901 may implement a software program, such as code generated manually (i.e., programmed).

The computer system 900 may include a memory 902, such as the memory 902 that can communicate via a bus 903. The memory 902 may be a main memory, a static memory, or a dynamic memory. The memory 902 may include, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one example, the memory 902 includes a cache or random access memory for the processor 901. In alternative examples, the memory 902 is separate from the processor 901, such as a cache memory of a processor, the system memory, or other memory. The memory 902 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 902 is operable to store instructions executable by the processor 901. The functions, acts or tasks illustrated in the FIG.s or described may be performed by the programmed processor 901 executing the instructions stored in the memory 902. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown, the computer system 900 may further include a display unit 904, such as a liquid crystal display (LCD), an organic light emitting diode (OLED), a flat panel display, a solid state display, a cathode ray tube (CRT), a projector, a printer or other now known or later developed display device for outputting determined information. The display unit 904 may act as an interface for the user to see the functioning of the processor 901, or specifically as an interface with the software stored in the memory 902 or in a drive unit 906.

The computer system 900 may also include a disk or optical drive unit 906. The disk drive unit 906 may include a computer-readable medium 907 in which one or more sets of instructions 908, e.g. software, can be embedded. Further, the instructions 908 may embody one or more of the methods or logic as described. In a particular example, the instructions 908 may reside completely, or at least partially, within the memory 902 or within the processor 901 during execution by the computer system 900. The processor 901 and the memory 902 may also include computer-readable media as discussed above.

The present disclosure contemplates a computer-readable medium that includes instructions 908 or receives and executes instructions 908 responsive to a propagated signal so that a device connected to a network 909 can communicate voice, video, audio, images or any other data over the network 909. Further, the instructions 908 may be transmitted or received over the network 909 via a communication port or interface 910 or using the bus 903. The communication port or interface 910 may be a part of the processor 901 or may be a separate component. The communication port 910 may be created in software or may be a physical connection in hardware. The communication port 910 may be configured to connect with the network 909, external media, the display unit 904, or any other components in computer system 900, or combinations thereof. The connection with the network 909 may be a physical connection, such as a wired Ethernet connection or may be established wirelessly as discussed later. Likewise, the additional connections with other components of the computer system 900 may be physical connections or may be established wirelessly. The network 909 may alternatively be directly connected to the bus 903.

The network 909 may include wired networks, wireless networks, Ethernet AVB networks, or combinations thereof. The wireless network may be a cellular telephone network, an 802.11, 802.16, 802.20, 802.1Q or Wi-Max network. Further, the network 909 may be a public network, such as the Internet, a private network, such as an intranet, or combinations thereof, and may utilize a variety of networking protocols now available or later developed including, but not limited to TCP/IP based networking protocols.

Additionally, the computer system 900 may include an input device 905 configured to allow a user to interact with any of the components of computer system 900. The input device 905 may be a number pad, a keyboard, or a cursor control device, such as a mouse, or a joystick, touch screen display, remote control or any other device operative to interact with the computer system 900.

In an alternative example, dedicated hardware implementations, such as application specific integrated circuits, programmable logic arrays, and other hardware devices, can be constructed to implement various parts of the computer system 900. Applications that may include the systems can broadly include a variety of electronic and computer systems. One or more examples described may implement functions using two or more specific interconnected hardware modules or devices with related control and data signals that can be communicated between and through the modules, or as portions of an application-specific integrated circuit. Accordingly, the present system encompasses software, firmware, and hardware implementations.

The system described may be implemented by software programs executable by a computer system. Further, in a non-limited example, implementations can include distributed processing, component/object distributed processing, and parallel processing. Alternatively, virtual computer system processing can be constructed to implement various parts of the system.

The system is not limited to operation with any particular standards and protocols. For example, standards for Internet and other packet switched network transmission (e.g., TCP/IP, UDP/IP, HTML, HTTP) may be used. Such standards are periodically superseded by faster or more efficient equivalents having essentially the same functions. Accordingly, replacement standards and protocols having the same or similar functions as those disclosed are considered equivalents thereof. It may be noted that the method as described in the present disclosure can be implemented in a wide variety of electronic devices including but not limited to desktop computers, laptop computers, palm top computers, tabs, mobile phones, televisions, etc. Also, the user input can be received by the system using a wide variety of techniques including but not limited to using a mouse, a gesture input, a touch input, a stylus input, a joystick input, a pointer input, etc.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present subject matter has been presented for purposes of example rather than limitation, and does not preclude inclusion of such modifications, variations, and/or additions to the present subject matter as would be readily apparent to one of ordinary skill in the art.

To the extent that apparatus embodiments herein are described as having certain numbers of elements, it should be understood that fewer than all of the elements may be necessary to define a complete claim. In addition, sequences of operations or functions described in various embodiments do not require or imply a requirement for such sequences in practicing any of the appended claims. Operations or functions may be performed in any sequence to effectuate the goals of the disclosed embodiments.

What is claimed is:

1. An optical device for irradiating a sample at a predetermined incidence angle and collecting a detection radiation at a predetermined collection angle, the optical device comprising:
a first electrically addressed spatial light modulator configured to block input light and produce an excitation radiation for irradiating a sample at the predetermined incidence angle;
a second electrically addressed spatial light modulator configured to produce the detection radiation corresponding to the predetermined collection angle; and
at least one controller configured to control at least one of: the predetermined incidence angle by controlling the first electrically addressed spatial light modulator and the predetermined collection angle by controlling the second electrically addressed spatial light modulator.

2. The optical device according to claim 1 wherein the first electrically addressed spatial light modulator includes a liquid crystal array.

3. The optical device according to claim 1 wherein the second electrically addressed spatial light modulator includes a liquid crystal array.

4. The optical device according to claim 1 wherein the first electrically addressed spatial light modulator includes a digital micro-mirror device.

5. The optical device according to claim 1 wherein the second electrically addressed spatial light modulator includes a digital micro-mirror device.

6. The optical device according to claim 1 further comprising a laser source configured to emit the input light.

7. The optical device according to claim 1 further comprising a polarizer configured to control a polarization state of the excitation radiation.

8. The optical device according to claim 7, wherein the polarizer includes liquid crystal based polarization controller.

9. The optical device according to claim 7, the polarizer includes quarter-wave plate based polarizer.

10. The optical device according to claim 1 further comprising at least one focusing element configured to focus the excitation radiation at the predetermined incidence angle onto a surface of the sample.

11. The optical device according to claim 10, wherein the at least one focusing element is further configured to collect a radiation emitted by the sample and produce a collimated radiation.

12. The optical device according to claim 1 further comprising a polarizer configured to control a polarization state of the detection radiation.

13. The optical device according to claim 12, wherein the polarizer includes liquid crystal based polarization controller.

14. The optical device according to claim 12, the polarizer includes quarter-wave plate based polarizer.

15. The optical device according to claim 1 further comprising a spectrometer configured to perform spectral analysis of the detection radiation.

16. An optical device for irradiating a sample at a predetermined incidence angle and collecting a detection radiation at a predetermined collection angle, the optical device comprising:
a source for generating an input light;
a first electrically addressed spatial light modulator located in an optical path of the input light, the first electrically addressed spatial light modulator being configured to partially block input light and produce an excitation radiation having predetermined spatial characteristics;
at least one focusing element configured to focus the excitation radiation at a predetermined incidence angle onto a surface of a sample, the predetermined incidence angle being based on the predetermined spatial characteristics of the excitation radiation, the at least one focusing element being further configured to collect radiation emitted by the sample and produce a collimated radiation;
a second electrically addressed spatial light modulator located in an optical path of the collimated radiation, the second electrically addressed spatial light modulator being configured to partially block the collimated radiation and produce a detection radiation having predetermined spatial characteristics, the predetermined spatial characteristics corresponding to a predetermined collection angle; and
at least one controller configured to control the predetermined incidence angle by controlling the first electrically addressed spatial light modulator, the at least one controller being further configured to control the predetermined collection angle by controlling the second electrically addressed spatial light modulator.

17. A method for irradiating a sample at a predetermined incidence angle and collecting detection radiation at a predetermined collection angle, the method comprising;
generating an input light;
partially blocking the input light by placing a first electrically addressed spatial light modulator along an optical path of the input light to produce an excitation radiation having predetermined spatial characteristics for irradiating the sample;
focusing the excitation radiation by at least one focusing element at the predetermined incidence angle onto a surface of the sample, the predetermined incidence angle being based on the predetermined spatial characteristics;
collecting radiation emitted from the surface of the sample by the at least one focusing element to produce a collimated radiation;
partially blocking the collimated radiation by placing a second electrically addressed spatial light modulator along an optical path of the collimated radiation to produce a detection radiation having predetermined spatial characteristics corresponding to the predetermined collection angle, the predetermined collection angle being controlled by the second electrically addressed spatial light modulator; and
controlling at least one of the first electrically addressed spatial light modulator and the second electrically addressed spatial light modulator by at least one controller to control the predetermined incidence angle and the predetermined collection angle.

18. The method as claimed in claim 17, wherein the method further comprises:
performing spectral analysis of the detection radiation by at least one controller to determine stress tensor of the sample based on the predetermined incidence angle and the predetermined collection angle.

19. The method as claimed in claim 17, wherein the method further comprises:
controlling a polarization angle of the excitation radiation during irradiating the sample by the at least one controller; and
performing spectral analysis of the detection radiation based on the polarization angle.

20. The method as claimed in claim 17, wherein the method further comprises:
controlling a polarization angle of the detection radiation by the at least one controller; and
performing spectral analysis of the detection radiation based on the polarization angle.
